(19) United States
(12) Patent Application Publication
(10) Pub. No.: US 2011/0303710 A1
(43) Pub. Date: Dec. 15, 2011

(54) Method and Apparatus for a Wrist Attachment for a Personal Electronic Device

(76) Inventor: David C. Yu, Laguna Niguel, CA (US)

(21) Appl. No.: 12/815,852

(22) Filed: Jun. 15, 2010

(51) Int. Cl. A45F 5/00; B23P 11/00

(52) U.S. Cl. 224/219; 29/428

(57) ABSTRACT

A method and apparatus for supporting a personal electronic device on a user's wrist are provided. The device incorporates a wrist strap attached to a base attachment leg. The base attachment leg is also attached to a friction hinge. The friction hinge is in turn attached to an extension arm. The extension arm may be a telescoping arm. The extension arm is also attached to a ball joint, which may be a friction ball joint or a locking ball joint. A case support leg is also attached to the ball joint. A case is attached to the case support leg and may also serve as protection for the electronic device. In use, the friction hinge allows for the electronic device to be moved into a viewing position at a desired angle. The ball joint allows rotation of the device between portrait and landscape orientations.

### BACKGROUND OF THE INVENTION

The present invention pertains to a method and apparatus for attaching a personal electronic device to a user's wrist.

Personal electronic devices have become extremely popular, providing on-the-go entertainment and data access as well as mobile phone service. As mobile phones have become more capable users take advantage of the many applications and features that the phones provide and frequently take the phone with them as they perform a variety of daily activities, including physical activities. Other personal electronic devices have also gained in use and popularity. Many users rely on these devices and use them extensively throughout their daily lives.

Personal electronic devices are often carried in a pocket or purse, or may be attached to a holster attached to a belt. In many cases, these carrying systems do not provide security for the device, or ease of access. While some cases may offer protection alone, this protection may not facilitate use and may take up room in a pocket or handbag.

When these personal electronic devices are in use a user typically holds them in the palm of the hand. Greater ease of use and protection could be achieved if the device were stowed near a user's palm to be quickly ready for use. In addition, holding a device in the palm for long periods of time may cause cramping and discomfort to the user.

There is a need in the art for a method and apparatus for supporting a personal electronic device on a user's wrist.

### SUMMARY OF THE INVENTION

An apparatus for supporting an electronic device on a user's wrist is provided. The apparatus includes a wrist strap attached to a base attachment leg, a friction hinge attached to the base attachment leg, an extension arm also attached to the friction hinge, a ball joint attached to the extension arm, a case support leg also attached to the ball joint, and a case attached to the case support leg.

A method of supporting and attaching an electronic device to a user's wrist is provided in a further embodiment. The method includes inserting an electronic device into a case, attaching the case to a case support leg of the wrist attachment system, and adjusting the electronic device to a viewing position using a ball joint, a friction hinge, and an extension arm.

A still further embodiment provides a method of protecting an electronic device. The method comprises inserting an electronic device into a case, wherein the case may be attached to a support leg attached to a wrist attachment system.

A further embodiment provides means for inserting an electronic device into a case, means for attaching a case to a case support leg of a wrist attachment system, and means for adjusting the electronic device to a viewing position using a ball joint and an extension arm.

Various aspects and embodiments of the invention are described in further detail below.

### BRIEF DESCRIPTION OF THE SEVERAL VIEWS OF THE DRAWINGS

The present invention described herein will become apparent from the following detailed description considered in connection with the accompanying drawings, which disclose several embodiments of the invention. It should be understood, however, that the drawings are designed for the purpose of illustration and not as limits of the invention.

FIG. 1 illustrates use of the attachment system for a wrist attachment system for a personal electronic device, according to an embodiment of the invention.

### DETAILED DESCRIPTION OF THE INVENTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides for an efficient and convenient apparatus for carrying, using, and protecting a personal electronic device attached to a user's wrist. The device incorporates a case which provides protection for the personal electronic device and a support system that allows a user to move the device into position for use, rotate and extend the device as needed for use, and then move the device into a stowed position on the underside of a user's wrist.

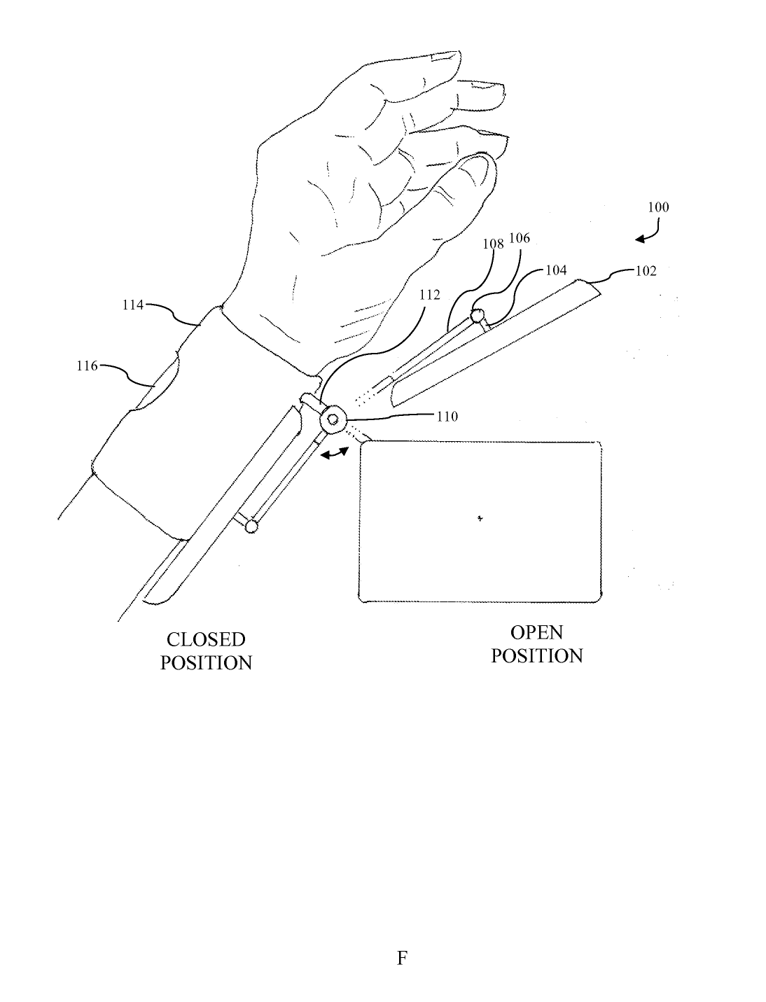

FIG. 1 illustrates use of the device. The wrist attachment system 100 includes case 102, which contains and protects the electronic device. The electronic device may be inserted face up into the case when the electronic device will be actively used, and may be inserted face down when not in use, allowing case 102 to protect the electronic device. Case 102 may also be detached from the wrist attachment system 100 and used separately.

Case 102 has an attachment point for a case support leg 104. Case support leg 104 extends from the back of case 102 to ball joint 106. Ball joint 106 allows the viewing angle to be adjusted to suit the user. In addition, ball joint 106 also allows rotating the case 102 containing the electronic device. This allows for additional adjustments to facilitate electronic device use in either portrait or landscape orientation. The open and closed positions of the wrist attachment system 100 are illustrated in FIG. 1. Ball joint 106 may be any suitable type of ball joint capable of providing the desired range of movement and may incorporate friction or locking mechanisms.

Ball joint 106 is connected to case support leg 104 and also to extension arm 108. Extension arm 108 may telescope to adjust length, thus accommodating user preferences and size variations. When the wrist attachment is not extended and in use, the telescoping mechanism of extension arm 108 allows the wrist attachment system 100 to maintain a low profile in the closed position as illustrated in FIG. 1.

Extension arm 108 also connects to friction hinge with lock 110. Friction hinge with lock 110 allows the wrist attachment system to be positioned as a user desires and to maintain that position until the lock mechanism is disengaged. Friction hinge with lock 110 provides stability for the electronic device when in use.

Friction hinge with lock 110 is also connected to base attachment leg 112. Base attachment leg 112 provides a connection with wrist strap 114. Base attachment leg 112 may be any length suitable, while still providing a low profile when wrist attachment system 100 is in the closed position.

Wrist strap 114 wraps around the user's wrist as shown in FIG. 1. Wrist strap 114 may be fabricated from any suitable material, such as leather, fabric, or plastic. Closure of wrist strap 114 may be by a variety of means, including but not limited to: threaded loop and stitching/gluing, clips, buckles, or other means. Watch opening 116 is provided on wrist strap 114 to allow a user to wear a wristwatch while using the wrist attachment system 100.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus for supporting an electronic device, comprising:
a wrist strap attached to a base attachment leg;
a friction hinge attached to the base attachment leg;
an extension arm also attached to the friction hinge;
a ball joint attached to the extension arm;
a case support leg also attached to the ball joint; and
a case attached to the case support leg.

2. The apparatus of claim 1, wherein the friction hinge includes a lock.

3. The apparatus of claim 1, wherein the extension arm is a telescoping arm.

4. The apparatus of claim 1, wherein the ball joint is a friction ball joint.

5. The apparatus of claim 1, wherein the ball joint includes a locking mechanism.

6. The apparatus of claim 1 wherein the case is detachable.

7. The apparatus of claim 1, wherein the case functions as a cover.

8. A method of supporting an electronic device, comprising:
inserting an electronic device into a case;
attaching a case to a case support leg of a wrist attachment system;
adjusting the electronic device to a viewing position using a ball joint, a friction hinge, and an extension arm.

9. A method of protecting an electronic device, comprising:
inserting an electronic device into a case, wherein the case may be attached to a support leg attached to a wrist attachment system.

10. An electronic device support apparatus, comprising:
means for inserting an electronic device into a cover;
means for attaching a case to a case support leg of a wrist attachment system;
means for adjusting the electronic device to a viewing position using a ball joint and an extension arm.
